(19) United States
(12) Patent Application Publication
(10) Pub. No.: US 2010/0031794 A1
(43) Pub. Date: Feb. 11, 2010

(54) PANEL SAW MACHINE

(75) Inventor: Piergiorgio Benuzzi, Bologna (IT)

Correspondence Address: Pearne & Gordon LLP, 1801 East 9th Street, Suite 1200, Cleveland, OH, 44114-3108, US

(73) Assignee: GIBEN INTERNATIONAL S.P.A., 40065 Pianoro (Bologna) (IT)

(21) Appl. No.: 12/445,438

(22) PCT Filed: Jul. 15, 2008
(86) PCT No.: PCT/IB2008/001858

§ 371 Date: Apr. 13, 2009

(30) Foreign Application Priority Data
Jul. 23, 2007 (IT) BO2007A000509

(51) Int. Cl. B27B 5/06

(52) U.S. Cl. 83/409

(57) ABSTRACT

A panel saw machine (1) for cutting panels (P1) comprises: a work table (4) for supporting panels (P1); a cutting unit (3) that moves along a respective cutting line (L) on the work table (4) to divide the panels into two or more sub-panels; a pusher assembly (5) that moves towards and away from the cutting line (L) in a direction (Y) transversal to the cutting line (L) to position at least one panel (P1) on the work table (4) at the cutting unit (3); to adjust its position, the pusher assembly (5) is also mobile in a direction (X) parallel to the cutting line (L) between a first operating position and other positions along the cutting line (L).

### TECHNICAL FIELD

This invention relates to a panel saw machine and, in particular, to a panel saw machine comprising a horizontal work table to support the panels and on which a mobile pusher assembly moves at least one panel.

### BACKGROUND ART

The work table extends principally in a longitudinal direction Y and the mobile pusher assembly comprises a panel abutment member or fence extending in a direction X substantially perpendicular to the direction Y.

In the specification of this invention, reference is made by way of example to panel saw machines in which the panel abutment fence (which also acts as a pushing element) is driven from below and through the work table; reference is also made to panel saw machines with a single cutting line.

Prior art panel saw machines also comprise a cutting unit, for example a revolving blade unit, that moves in X and is designed to saw a panel or stack of panels in the direction X transversal to the direction Y. At the cutting unit, the machine comprises a presser unit which keeps the panels in place while they are being cut.

The pusher moves towards and away from the cutting unit not only to drive the panels over the work table towards the cutting unit but also to define an abutment to stop the panels at a predetermined distance from the cutting line.

The mobile pusher assembly may comprise a plurality of elements (normally referred to as gripper clamps) for picking up and holding the panels and suitably mounted on the abutment element.

The pick-up elements, for example of the clamping type, are designed to grip the stack of panels or the individual panels in such a way that the panels can be moved towards and away from the cutting line.

On the part of the work table on the opposite side of the cutting line, these machines also comprise a plurality of low-friction tables for supporting and receiving the cut panels as they feed out of the cutting line.

The pusher of a panel saw machine of this kind moves along a straight guide usually mounted under the work table.

The guide is fixed, normally fastened to the floor, and extends in the direction Y in a central or middle position relative to the work table or to the cutting line and abutment element itself.

In practice, the mobile pusher assembly whose abutment element extends across the full width of the work table, is guided and supported centrally with respect to the work table itself.

This type of structure has inherent disadvantages.

In the case of front loaded panels, if the panels come into contact with the abutment element in a lateral or offset position, the abutment element tends to swing heavily since it is fixed at the centre only. This is quite a common situation since panel saw machines usually have a lateral contact member or fence for the panels which helps keep the panels in the correct cutting position, and hence the need to align the panels laterally.

The problem is further worsened by the fact that the panels are cut both longitudinally and transversally, the longitudinal cuts being made while the panels are positioned on the side of the work table opposite the fence so as to leave enough room to turn them in order to cut them transversally while keeping them in contact with the lateral fence.

Thus, the abutment beam is stressed alternately on one side and the other of the central guide.

As a result, the abutment element may become slack and lose its precise position relative to the cutting unit, leading to errors in cutting the panels which can only be avoided by adopting large, heavy and hence expensive machine structures.

In another very common constructional form, a pusher carriage extending across the full width of the machine runs on guides positioned on both sides of the work table. This constructional form, though it guarantees high strength and rigidity, involves high production costs and is usually unnecessary for machines in which the panels are loaded from the front.

### DISCLOSURE OF THE INVENTION

In this context, the main purpose of this invention is to provide a panel saw machine with a pusher that is free of the above mentioned disadvantages.

The aim of this invention is to provide a panel saw machine that can operate on the panels while keeping them in a substantially centred position relative to the mobile pusher assembly.

Another aim of the invention is to provide a panel saw machine having a simple and relatively inexpensive structure.

Yet another aim of the invention is to provide a panel saw machine that is versatile and easy to assemble.

The stated technical purpose and aims of the invention are substantially achieved by a panel saw machine as described in claim 1 and in one or more of the claims dependent thereon.

### BRIEF DESCRIPTION OF THE DRAWINGS

Further characteristics and advantages of the invention are more apparent in the detailed description below, with reference to a preferred, non-limiting, embodiment of a panel saw machine, illustrated in the accompanying drawings in which:

FIG. 1 is a schematic top plan view, with some parts cut away for clarity, of a panel saw machine according to the invention in a first operating configuration;

FIG. 2 is a schematic top plan view, with some parts cut away for clarity, of the machine of FIG. 1 in a second operating configuration;

FIG. 3 is a schematic side view, with some parts in blocks and other cut away for clarity, of the machine of FIG. 1.

### DETAILED DESCRIPTION OF THE PREFERRED EMBODIMENTS OF THE INVENTION

With reference to the accompanying drawings, the numeral 1 denotes in its entirety a panel saw machine according to this invention.

In particular, the panel saw machine 1 referred to in this specification is of substantially known type and therefore not described in detail and has a single sawing axis for cutting whole panels P1, P2 or portions or strips of panels.

The machine 1 comprises a base 2 which extends in a direction X.

At the base 2, the machine 1 comprises a cutting unit 3, for example of the type with a revolving blade, that moves in X along a respective cutting line L to saw the panels P1, P2.

A horizontal work table 4 for supporting the panels and extending principally in a direction Y perpendicular to the direction X is mounted on the base 2, as described below, substantially at the cutting unit 3.

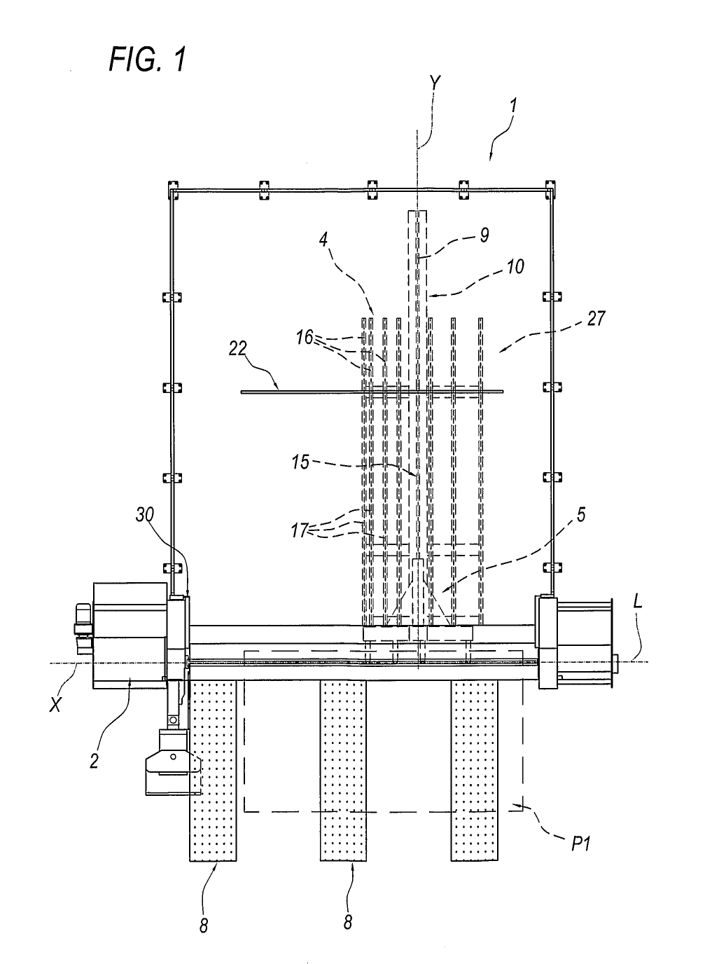

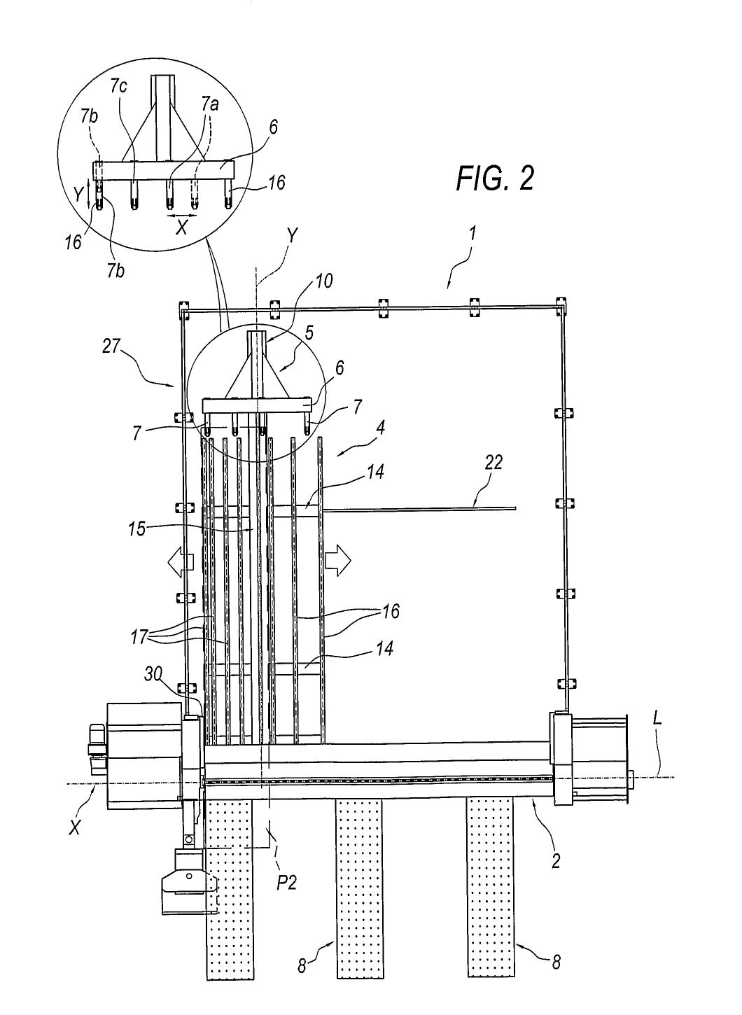

To one side of the work table 4, for example on the left in FIGS. 1 and 2, the machine 1 comprises a contact element 30, commonly known as “fence”, for abutting the panels being processed.

The machine 1 further comprises a mobile pusher assembly 5 for moving and positioning the panels on the table 4.

In particular, the pusher assembly 5 is mobile in Y between a position, indicated by a continuous line, where it is away from the cutting line L, and a position, indicated by a dashed line in FIG. 2, where it is close to the cutting line L.

The mobile pusher assembly 5 comprises an element or beam 6 for abutting the panels and extending in the direction X.

The mobile pusher assembly 5 also comprises a plurality of elements 7 for gripping and holding the panels P1, P2 and suitably mounted in known manner on the abutment element 6.

The pick-up elements 7, for example of the clamping type, are designed to grip the stack of panels or the individual panels in such a way that the panels can be moved towards and away from the cutting line L.

As illustrated in FIG. 2, the pick-up elements 7 comprise a pick-up element 7a mounted on the beam 6 and mobile along the beam in the direction X between a first operating position and a second operating position illustrated by a dashed line.

Drive means of substantially known type and therefore not described here are associated with the element 7a and move the latter along the beam 6.

As illustrated in FIG. 2, the mobile pusher assembly 5 comprises a pick-up element 7b mounted on the beam 6 and mobile between a position, illustrated by a dashed line, where it is close to the beam 6 and a position where it is away from the beam in the direction Y.

Drive means of substantially known type and therefore not described here are associated with the element 7a and move the latter along the beam 6.

Advantageously, the mobility of the pick-up element in X and Y as described above are combined in a single pick-up element 7c which is mobile in both X and Y.

On the part of the work table 4 on the opposite side of the cutting line L, the machine 1 comprises a plurality of low-friction tables 8 for supporting and receiving the cut panels as they feed out of the cutting line L.

The machine 1 comprises a guide 9 along which the pusher assembly 5 moves; the pusher assembly 5 is driven by substantially known drive means, not illustrated, such as a rack, a lead screw, a transmission belt or a transmission cord or cable.

The guide 9 extends in the direction Y and is located along a beam 10 and secured to the base 2.

The mobile pusher assembly 5 comprises a main body 11 slidably connected to the guide 9 that mounts the panel abutment beam 6.

The machine 1 comprises one or more work table 4 brackets 12 attached to the beam 10.

Each bracket 12 has an upright member 13 associated with the beam 10 and a horizontal arm 14 that supports the table 4.

It is important to note that the work table 4 has a longitudinal opening 15 to allow the mobile pusher assembly 5 to move towards and away from the cutting line L.

Preferably, the work table 4 is composed of a plurality of separate longitudinal members 16 supported by the arms 14 and fitted with low-friction running elements 17 such as wheels.

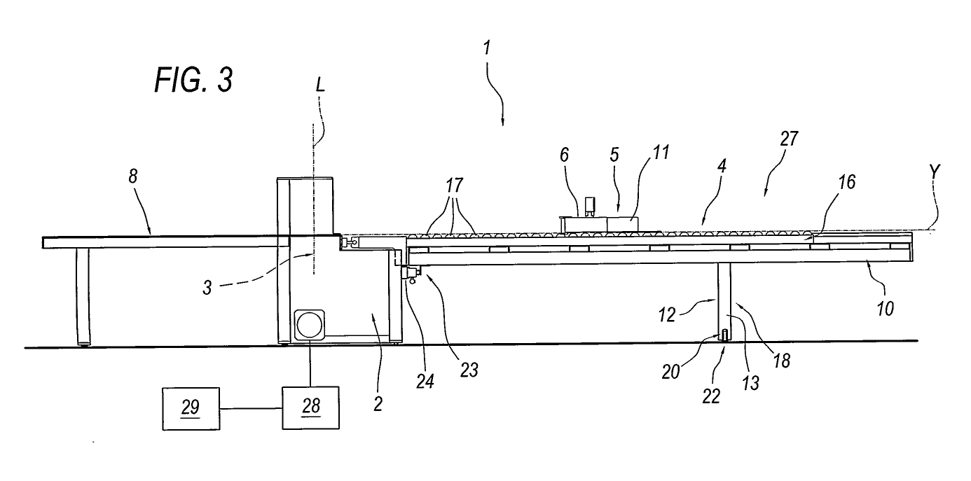

FIG. 3 in particular shows how the beam 10 is mounted on a supporting leg 18.

The leg 18 is provided with at least one wheel 20 that enables it to be moved so that the beam 10, the mobile pusher assembly 5 and the work table 4 can be moved in the direction X.

Preferably, the machine 1 comprises a guide 22 for the wheels 20 of the leg 18; it should be noticed that the guide 22 advantageously extends in the direction X.

Advantageously, one end 23 of the beam 10 is slidably connected to a respective guide 24 located in the base 2 and extending in the direction X.

In this way, the beam 10 is supported by the leg 18 and at the guide 24.

The beam 10, the supporting leg 18, the mobile pusher assembly 5, the work table 4 and its brackets 12 together form a mobile structure 27.

More specifically, the structure 27 is mobile between a first operating position, illustrated by a dashed line in FIG. 1, and a second operating position away from the first position in X, illustrated in FIG. 2.

By way of example, FIG. 1 shows the panel P1 while it is being cut longitudinally, whilst FIG. 2 shows the panel P2 being cut transversally.

Preferably, at the first operating position, the structure 27 is located on the right, looking at FIG. 1, away from the abutment element 30, whilst in the second operating position, it is in abutment against said element.

Preferably, the machine 1 comprises means for driving the structure 27 in the direction X, schematically illustrated as a block 28 and not described in detail.

The drive means 28 are controlled by a computerized control unit 29 which coordinates the movements of the structure 27.

Thus, the mobility of the structure 27 is suitably controlled and programmable through a succession of intermediate positions between the first and the second positions.

The invention, as described above, has important advantages.

The mobile structure enables the panels to be positioned substantially centrally every time relative to the mobile pusher assembly.

When the panels have to be moved from one side of the machine to the other for further cutting, the pusher assembly can be moved accordingly so that the relative position remains optimal.

The mobile structure is relatively simple and easy to produce on industrial scale.

The characteristics as described above make the machine ideal for small, compact and cost-effective installations.

Compactness also means that the structure 27 can be shipped in assembled condition, thus greatly facilitating installation on the end user's premises, which in turn means lower commissioning costs for the panel saw machine.

It will be understood that the invention can be modified and adapted in several ways without thereby departing from the scope of the inventive concept. Moreover, all the details of the invention may be substituted by technically equivalent elements.

1. A panel saw machine for cutting panels (P1, P2) comprising
a work table (4) for supporting the panels (P1, P2);
a cutting unit (3) that moves along a respective cutting line (L) on the work table (4) to divide the panels into two or more sub-panels;
a pusher assembly (5) that moves towards and away from the cutting line (L) in a direction (Y) transversal to the cutting line (L) to position at least one panel (P1, P2) on the work table (4) at the cutting unit (3);
the machine being characterized in that the mobile pusher assembly (5) is mobile, to adjust its position, in a direction (X) parallel to the cutting line (L) between a first operating position and a second operating position.

2. The machine according to claim 1, characterized in that the work table (4) is mobile in the direction (X) parallel to the cutting line (L) and parallel to the mobile pusher assembly (5).

3. The machine according to claim 1, characterized in that the mobile pusher assembly (5) can move towards and away from the cutting line (L) on a respective guide (9), the guide (9) being mobile in the direction (X) parallel to the cutting line (L).

4. The machine according to claim 3, characterized in that the work table (4) is associated with and supported by the guide (9).

5. The machine according to claim 1, characterized in that it comprises a base (2), the mobile pusher assembly (5) being slidably connected to the base (2) and the base (2) extending along the cutting line (L).

6. The machine according to claim 3, characterised in that the guide (9) is slidably secured to the a base (2).

7. The machine according to claim 5, characterized in that the work table (4) is slidably connected to the base (2), in particular through the guide (9).

8. The machine according to claim 3, characterized in that it comprises at least one leg (18) for supporting the guide (9) on the floor, the leg (18) being provided with low-friction running means (20).

9. The machine according to claim 8, characterized in that it comprises a guide (22) for the low-friction running means (20), said guide (22) extending in particular in a direction parallel to the cutting line (L).

10. The machine according to claim 1, characterized in that the mobile pusher assembly (5), the work table (4) and a guide (9) for the mobile pusher assembly, on which the mobile pusher assembly (5) can move towards and away from the cutting line (L), together form a structure (27) that moves in a direction parallel to the cutting line (L), the work table (4) being, in particular, supported by the guide (9).

11. The machine according to claim 10, characterized in that it comprises a base (2), the structure (27) being slidably secured to the base (2).

12. The machine according to claim 2, characterized in that the work table (4) can move, together with the mobile pusher assembly (5), in the direction (X) parallel to the cutting line (L).

13. The machine according to claim 1, characterized in that the mobile pusher assembly (5) comprises a beam (6) for abutting the panels (P1, P2) and at least one pick-up element (7) mounted on the abutment beam (6) for gripping the panels (P1, P2) and moving them on the work table (4).

14. The machine according to claim 1, characterized in that the mobile pusher assembly (5) comprises a beam (6) for abutting the panels (P1, P2) and at least one pick-up element (7a, 7c) mounted on the abutment beam (6) and driven by respective drive means along the beam, in particular in the direction (X) parallel to the cutting line (L).

15. The machine according to claim 1, characterized in that the mobile pusher assembly (5) comprises a beam (6) for abutting the panels (P1, P2) and at least one pick-up element (7b, 7c) that moves between a position where it is close to the abutment beam (6) and a position where it is away from the beam, in particular in the direction (Y) transversal to the cutting line (L).
